(19) United States
(12) Patent Application Publication
(10) Pub. No.: US 2020/0324451 A1
(43) Pub. Date: Oct. 15, 2020

(54) SPACER FOR INSULATING GLAZING UNITS, METHOD FOR PRODUCING THE SPACER AND MULTIPLE INSULATING GLAZING UNIT

(71) Applicant: SAINT-GOBAIN GLASS FRANCE, Courbevoie (FR)

(72) Inventors: Hans-Werner KUSTER, AACHEN (DE); Walter SCHREIBER, AACHEN (DE); Marc MAURER, SAINT JEAN AUX BOIS (FR); Bianca BERGS, GANGELT (DE)

(21) Appl. No.: 16/097,610

(22) PCT Filed: Aug. 7, 2017
(86) PCT No.: PCT/EP2017/069947

§ 371 Date: Oct. 29, 2018

(30) Foreign Application Priority Data
Sep. 14, 2016 (EP) 16188741.9

(51) Int. Cl. B29C 48/07; E06B 3/663; B29C 48/12

(52) U.S. Cl. CPC B29C 48/07; E06B 3/66319; B29K 2821/003; B29C 48/12; E06B 3/66366

(57) ABSTRACT

A spacer for insulating glazing units is presented. The spacer includes a main body having first and second pane contact legs that are parallel, first and second glazing interior legs, an outer leg, first and second hollow chambers extending along an extension direction, and a groove for receiving a pane. Arranged in the groove, there is an extruded pane receiving socket formed from a polymer having a Shore hardness A in a range from 10 to 80 as measured per DIN ISO 7619-1. In a surface of the pane receiving socket, a receiving recess running substantially parallel to the groove and decreasingly tapering viewed in cross-section in a direction of the outer leg is implemented. Also described are a method for producing the spacer and a multiple insulating glazing unit having the spacer.

The invention relates to a spacer for insulating glazing units, a method for producing such a spacer and a multiple insulating glazing unit constructed with such a spacer. In particular, the invention relates to a spacer for triple insulating glazing units, a method for production thereof and a triple insulating glazing unit.

WO2014/198431 describes a spacer for insulating glazing units, comprising an extruded main body having
a first pane contact leg,
a second pane contact leg running parallel thereto,
a first glazing interior leg,
a second glazing interior leg,
an outer leg,
a first hollow chamber extending along an extension direction,
a second hollow chamber extending parallel to the extension direction, and
a groove with a first groove side leg and a second groove side leg for receiving a pane, wherein the groove between the first hollow chamber and the second hollow chamber runs along the extension direction; and, viewed in cross-section, the first hollow chamber is enclosed by the first pane contact leg, the first glazing interior leg, and a first section of the outer leg; and the second hollow chamber is enclosed by the second pane contact leg, the second glazing interior leg, and a second section of the outer leg, wherein an extruded pane receiving socket is arranged in the groove extending along the extension direction at least in sections.

The first pane contact leg serves for fixing on a first pane, and the second pane contact leg serves for fixing on a second pane. The groove runs parallel to the two hollow chambers and serves to receive a third pane.

The first hollow chamber adjoins the first glazing interior leg, whereas the second hollow chamber adjoins the second glazing interior leg, with the glazing interior legs delimiting the hollow chambers at the top and the outer leg delimiting the hollow chambers at the bottom. In this context, the term “at the top” means “facing the interpane space of an insulating glazing with a spacer according to the invention” and “at the bottom” means “facing away from the interpane space”. The pane contact legs and the groove side leg are, in each case, the connection between the glazing interior legs and the outer leg.

Since the groove runs between the first glazing interior leg and the second glazing interior leg, it delimits them laterally and separates the first hollow chamber and the second hollow chamber from one another.

The invention relates to a one-piece doubled spacer, which is also referred to as a “double spacer” and on which, in one embodiment, all three panes of a triple insulating glazing unit can be fixed. The two outer panes (first pane and second pane) are mounted on the pane contact legs and the middle inner pane is arranged in the groove separating the two hollow chambers.

A special feature in the structure of a multiple insulating glazing unit using such a double spacer consists in that the inner pane arranged in the groove does not form a hermetically sealed interface with the groove. Such a sealed fixing is also quite intentionally undesirable, for example, in order to ensure pressure equalization between the compartments to the right and left of the middle pane. This has, for example, in the case of the deforming effects of wind loads on the outer pane, the advantage that the increase in pressure in the glazing interior can be absorbed by both compartments. Depending on how the inner pane is arranged in the groove, a narrow gap can form in the case of a non-consistently ensured mechanical contact between the groove and the edge of the inner pane. The regions separated by a gap have, depending on their dimensions, natural frequencies that can be resonantly excited by external vibration sources. This can, in turn, result in bothersome vibration noises. In order to prevent the development of such vibration noises, it is common to insert into the groove of the spacer an insert made of an elastomer that can be deformed by the inner pane, for example, made of ethylene diene rubber. However, the insertion of such an insert complicates the methods for producing the spacer of the triple insulating glazing unit. Such spacers are commonly produced by extrusion in continuous mode. At the time of construction of multiple insulating glazing units, the spacers thus produced are cut to necessary dimensions by sawing and/or milling operations. However, during the sawing and/or milling operations, inserts placed in the groove frequently break loose out of the groove. Consequently, the production of a multiple insulating glazing unit is difficult due to the structure of the spacer described.

Furthermore, it is known from WO2016/091646 A1 to arrange a gas-permeable insert in the groove. The gas-permeable insert can be coextruded with the polymeric main body or slid or plugged into the groove. The coextrusion of the insert along with the polymeric main body is, however, difficult to achieve in practice.

Furthermore, known from EP3020908A1 is a spacer that has an outer shell that encloses an internal structure, for example, desiccant, wherein the outer shell is present as a composite resulting from extrusion along with the internal structure. The spacer can be implemented as a double spacer and have a groove for receiving a middle inner pane that is firmly bonded to the spacer by means of an adhesive glue.

DE2835669A1 also describes a multipane assembly of which the panes are separated from one another by a spacer that is bonded to them by means of an adhesive.

US2014/0109499A1 further describes a double spacer with a groove, of which the groove side legs forming it are bonded to a middle inner pane by means of an adhesive. Alternatively, an elongate seal can also be provided, which engages with a first glazing interior leg and a second glazing interior leg and can receive the middle inner pane. The glazing interior legs protrude into the groove formed by the groove side legs.

WO2016/068305A1 discloses a spacer with one or a plurality of grooves for receiving one or a plurality of middle inner panes. Each groove has an insert that holds the respective inner pane in a clamp-like manner. The insert is a vinyl chloride resin or urethane resin with Shore hardness in the range from 50 to 90 or a rubber, in order to provide adequate retaining force. It is arranged only in partial contact with the groove in order to equalize pressure in compartments between the inner panes, which changes, for example, with temperature changes.

The object of the present invention is to provide a spacer for insulating glazing units, a method for producing such a spacer, and a multiple insulating glazing unit constructed out of such a spacer that are simpler to produce or to carry out and thus save costs.

The object of the present invention is accomplished according to the invention by a spacer for insulating glazing units, a method for production thereof, and a multiple insulating glazing unit according to independent claims 1, 8, and 13. Preferred embodiments of the invention are apparent from the dependent claims.

Provision is made according to the invention for the pane receiving socket to be formed from a polymer, in the surface of which a receiving recess is implemented, running substantially parallel to the groove and decreasingly tapered viewed in cross-section in the direction of the outer leg, and wherein the polymer has Shore hardness A in the range from 10 to 80, preferably in the range from 20 to 60, and particularly preferably in the range from 40 to 60, measured per DIN ISO 7619-1.

The spacer according to the invention enables, through the provision, at least in sections, of a pane receiving socket at the bottom of the groove, a precise and non-hermetic mounting of the or an inner pane of a multiple insulating glazing unit, in particular, of a triple glazing unit. The selection of the polymer for the pane receiving socket in the Shore hardness range claimed offers, first, good mechanical support of the inner pane in the groove. By means of the receiving recess decreasingly tapered in the direction of the outer leg, a mechanically robust grip of the outer edge of the pane is ensured. Thus, unwanted rattling noises or resonance effects that are caused by pane outer edges that are not firmly fixed can no longer occur. The receiving recess is tapered. Thus, it has, viewed in the introduction direction of an inner pane, a decreasing width, whereby the receiving recess becomes at least small enough that the pane outer edge of the inner pane is gripped mechanically. Thus, the receiving recess can, by tapering, become even narrower than the thickness of the inner pane such that, by this means, the mechanical securing of the pane outer edge is forced by the geometric configuration.

The Shore hardnesses of the polymers selected are, moreover, soft enough in comparison with the glass material of the pane introduced to realize a gentle mechanical fixing of the pane outer edges. Second, such polymers can be readily separated during the sawing and milling operations for cutting the spacer to size without damage to tools, since, due to their hardness, they can be severed by machining, without clogging. This desired effect does not depend solely on the separating tool and the operating parameters of the separating tool. The selection of the polymer hardness according to the invention thus enables cost-effective further processing of the spacer.

Furthermore, the fixing of the inner pane according to the invention is done by the groove with the polymeric pane receiving socket. Thus, the spacer according to the invention enables, in particular, production of a triple glazing unit with a low-E coating on the inner pane without requiring prestressing of the inner pane. Instead, with the use of the spacer according to the invention, the prestressing process is eliminated, as a result of which an additional cost reduction can be achieved. By means of the stress-free fixing according to the invention in the groove with the pane receiving socket, the thickness and, thus, the weight of the inner pane can, furthermore, be advantageously reduced.

The Shore hardness can be measured with various hardness measuring instruments. For relatively soft elastomers, Shore A measuring instruments with a needle with a blunted point are generally used; and for relatively stiff plastics Shore D measuring instruments with a needle with a spherical tip are used. Shore A and Shore D values can be compared with one another or overlap. In a preferred embodiment, the polymer of the receiving socket has Shore hardness A 50, measured per DIN ISO 7619-1.

The first pane contact leg and the second pane contact leg constitute the sides of the spacer on which, at the time of installation of the spacer, the mounting of the outer panes (first pane and second pane) of a multiple insulating glazing unit is done. The first pane contact leg and the second pane contact leg run parallel to one another. The outer leg of the polymeric main body is the side of the spacer opposite the glazing interior legs, facing away from the interior of the insulating glazing unit and, optionally, in the direction of an external insulating film. The outer leg preferably runs perpendicular to the pane contact legs. However, the sections of the outer leg nearest the pane contact legs can, alternatively, be inclined at an angle of preferably 30° to 60° relative to the outer leg running perpendicular to the pane contact legs in the direction of the pane contact legs. This angled geometry improves the stability of the polymeric main body and enables better adhesive bonding of the spacer according to the invention to an insulating film that is optionally applied on the outer leg of the spacer. An outer leg that extends perpendicular over its entire width to the pane contact legs has, on the other hand, the advantage that the sealing surface between the spacer and the pane contact legs is maximized and that the production process is facilitated by the resultant simpler shaping.

Preferably, the groove is wider than the thickness of the inner pane to be mounted therein such that the polymeric pane receiving socket can be introduced into the groove such that it prevents mechanical movement of the pane and noise development caused thereby, for example, during opening and closing of the window or in the case of resonance effects from external sound sources. The polymeric pane receiving socket further compensates the thermal expansion of the inner pane during warming such that stress-free fixing is ensured, independent of climatic conditions.

In a preferred embodiment, the tapering receiving recess is molded into the surface of the extruded polymer of the pane receiving socket. The molding-in of the receiving recess is done, for example, by a profiling tool, for example, a stamping tool. The profiling tool penetrates via the surface of the not yet cooled extruded polymer of the pane receiving socket into this viscous polymeric mass such that the receiving recess is formed in the pane receiving socket. Since a stamping force to form the receiving recess is exerted via the profiling tool, it is not possible to coextrude the main body and the pane receiving socket. Were this done, there would be a risk, due to the exertion of the stamping force, of deforming not only the viscous polymer of the pane receiving socket but also adjacent sections of the likewise still viscous polymeric main body. The surface of the extruded pane receiving socket polymer embossed by the profiling tool is a structural feature that makes this spacer distinguishable from other extruded spacers in which the pane receiving socket in the groove is implemented as a separate insert or in which the pane receiving socket is coextruded.

Preferably, the polymer of the pane receiving socket as a thermoplastic elastomer (TPE) is selected from the group consisting of TPA (also referred to as TPE-A or polyamide-TPE), TPC (also referred to as TPE-C or copolyester-TPE), TPS (also referred to as TPE-S or styrene-TPE), TPU (also referred to as TPE-U or urethane-TPE), or TPV (also referred to as TPE-V or TPE with cross-linked rubber). More preferably, the polymer is selected from the group consisting of TPU. Preferably, the TPU is TPU-ARES (aromatic hard segment, polyester soft segment), TPU-ARET (aromatic hard segment, polyether soft segment), or TPU-AREE (aromatic hard segment, soft segment with ether and ester linkages); likewise suitable are aliphatic TPUs.

The pane receiving socket is preferably arranged in the interior of the groove. Also, the pane receiving socket preferably does not protrude beyond the upper edge of the groove. In particular, the pane receiving socket does not protrude beyond the glazing interior leg extending at right angles to the groove and beyond the two groove side legs. The pane receiving socket is preferably arranged in the groove such that it covers the bottom of the groove, at least in sections. The polymeric pane receiving socket or the polymeric pane receiving socket sections adhere to the bottom of the groove. This adhesion can be achieved by means of a separate adhesive means or can develop automatically during the production process by the solidification of the polymeric pane receiving socket on the bottom of the groove.

In the pane receiving socket, a receiving recess is implemented, running substantially parallel to the groove and decreasingly tapered viewed in cross-section in the direction of the outer leg. The receiving recess thus has a varying width, wherein its smallest width is less than or equal to the thickness of the inner pane to be introduced into the groove and the receiving recess. The thickness of the groove side legs forming the groove can vary. Preferably, the thickness of the groove side legs forming the groove is constant, and the groove side legs forming the groove also have a decreasing taper viewed in cross-section in the direction of the outer leg. Due to the tapering geometry, less material is necessary for the pane receiving socket, of which the polymer is extruded in the region of the bottom of the groove, to form a pane receiving socket. Since the polymers with the claimed Shore hardnesses have a high price compared to the polymers for the extruded main body, a further reduction of the spacer production price can be achieved through the groove side legs arranged tapering toward one another. Moreover, this increases the volume of the first hollow chamber and of the second hollow chamber such that more desiccant can be introduced there. Thus, the service life of the spacer in an installed situation is increased.

Preferably, the pane receiving socket runs continuously in the groove viewed along the extension direction and has a substantially uniform cross-sectional area. The pane receiving socket arranged continuously in the groove preferably covers the bottom and the flanks of the first and second groove side legs forming the groove. Preferably, the pane receiving socket covers the inner surface of the groove completely or substantially completely, to the extent possible from a production technology standpoint.

Alternatively preferably, the pane receiving socket is segmented, with adjacent segments spaced relative to one another such that the pane receiving socket is arranged in sections in the groove and has a substantially uniform cross-sectional area. As a result of the segmented arrangement, a gas exchange between the volumes to the right and left of the third pane is simplified. Preferably, adjacent segments of the pane receiving socket are arranged from 5 to 50 mm apart, preferably 10 to 30 mm, more preferably 15 to 25 mm. The segments preferably have equal dimensions viewed in the extension direction. For example, a segment extends 15 mm, preferably 20 mm along the groove in the extension direction. In each case the segments of the pane receiving socket preferably cover the bottom of the groove and extend along the flanks of the first and second groove side legs forming the groove.

Preferably, a bottom surface of the groove is directly adjacent the outer leg of the polymeric main body, without one or both hollow chambers extending below the groove. Thus, a greatest possible depth of the groove is obtained, with the surfaces of the groove side legs or sections of the pane receiving socket adjacent thereto maximized for stabilization of the inner pane in a multiple insulating glazing unit.

The first groove side leg and the second groove side leg of the groove can run either parallel to the pane contact legs or be inclined in one direction or another. Preferably, an incline of these groove side legs in the direction of the inner pane to be inserted in the multiple insulating glazing unit creates a downward decreasing taper that serves to reduce the polymer volume of the pane receiving socket to be introduced into the groove and to increase the volumes of the hollow spaces for receiving desiccant.

When the groove side legs are inclined such that they form a downward tapering groove in the direction of the inner pane to be introduced in the multiple insulating glazing unit, they can have a varying thickness or a constant thickness. In the first case, only the flanks of the groove side legs adjacent the groove are inclined, whereas flanks of the groove side legs adjacent the hollow spaces run parallel to the pane contact legs. In the latter case, both the flanks adjacent the groove and the flanks of the groove side legs adjacent the hollow spaces are inclined. The latter case is preferable.

Furthermore, curved side legs are also conceivable, in which case only the middle section of the groove side legs and the pane receiving socket arranged thereon rest against the inner pane. The curved groove side legs have a very good spring action, in particular with small wall thicknesses. This further increases the flexibility of the groove side legs such that thermal expansion of the inner pane can be advantageously compensated. In a preferred embodiment, the curved groove side legs are made of a different material than the polymeric main body and are coextruded therewith. This is particularly advantageous since, thus, the flexibility of the groove side legs can be selectively increased by the selection of a suitable material, whereas the stiffness of the polymeric main body is retained.

In an already mentioned preferred embodiment, the first groove side leg and the second groove side leg are arranged such that the groove tapers in the direction of the outer leg. The first and second groove side legs are inclined inward relative to the perpendicular or substantially perpendicular pane contact legs in the direction of an inner pane to be received in the groove. Preferably, the pane receiving socket also tapers in the direction of the outer leg. The pane receiving socket and the groove side legs can have the same or a different degree of taper. Preferably, they have the same degree of taper.

As a variant, the polymer of the pane receiving socket is contrastingly colored compared to the main body. With the use of a polymer colored as desired, it is possible to adapt the color according to the wishes of the user or manufacturer and thus the resultant appearance blends harmoniously into its environment. The polymeric main body and the material of the groove can also be colored. Preferably, the polymer of the pane receiving socket has a color that has little or no contrast relative to the surface of the surrounding main body. Thus, the receiving socket does not attract attention as an additionally provided polymeric component and achieves a neutral visual appearance.

The pane receiving socket is molded directly onto the main body and is thus implemented in one piece therewith, with the pane receiving socket being molded directly onto the polymeric main body in a second extrusion step following the extrusion step for producing the main body. The material of the pane receiving socket is, in this case, selected such that it adheres well on the main body. In particular, the aforementioned thermoplastic elastomers are ideally suitable as pane receiving socket material due to their Shore hardness and adhesion.

The main body preferably has, along the glazing interior leg, a total width from 10 mm to 60 mm, particularly preferably from 20 mm to 36 mm. The selection of the width of the glazing interior leg, for example, in a triple insulating glazing unit, determines the distance between the first and the inner pane or between the inner pane and the second pane. Preferably, the widths of the first glazing interior leg and the second glazing interior leg are the same. Alternatively, asymmetrical spacers, in which the two glazing interior legs have different widths, are also possible. The precise dimension of the glazing interior leg is governed by the dimensions of the insulating glazing unit and the desired sizes of the interpane spaces.

The main body preferably has, along the pane contact leg, a height from 5 mm to 15 mm, particularly preferably from 5 mm to 10 mm. The groove preferably has a depth from 1 mm to 15 mm, particularly preferably from 2 mm to 4 mm. The pane receiving socket preferably has a depth from 0.5 mm to 14.5 mm, preferably from 1 mm to 3 mm.

The wall thickness of main body is, in particular in a embodiment made of polymers, preferably 0.5 mm to 15.0 mm, more preferably 0.5 mm to 10.0 mm, particularly preferably 0.7 mm to 1.0 mm.

The spacer preferably includes an insulating film on the outer leg of the main body that is also referred to as an outer insulating film. The insulating film includes at least one polymeric layer as well as a metallic layer or a ceramic layer. The layer thickness of the polymeric layer is between 5 μm and 80 μm, whereas metallic layers and/or ceramic layers with a thickness from 10 nm to 200 nm are used. Within the layer thicknesses mentioned, particularly good leakproofness of the insulating film is achieved.

The insulating film particularly preferably includes at least two metallic layers and/or ceramic layers that are arranged alternatingly with at least one polymeric layer. Preferably, the outer layers are formed by the polymeric layers. The alternating layers of the insulating film can be bonded to one another or applied on one another using a wide variety of methods known from the prior art. Methods for deposition of metallic or ceramic layers are well known to the person skilled in the art. The application of multiple thin layers can be advantageous in comparison with one thick layer since with increasing layer thickness, the risk of adhesion problems increases. Also, thicker layers have higher thermal conductivity such that such a film is less suitable thermodynamically.

The polymeric layer preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably contains iron, aluminum, silver, copper, gold, chromium, and/or alloys or mixtures thereof. The ceramic layer preferably contains silicon oxides and/or silicon nitrides.

The outer insulating film preferably has gas permeation less than 0.01 g/(m² h).

The composite of the polymeric main body and the outer insulating film preferably has a PSI value less than or equal to 0.05 W/mK, particularly preferably less than or equal to 0.035 W/mK. The insulating film can be applied on the polymeric main body, for example, glued.

The polymeric main body preferably includes in its hollow chambers a desiccant, preferably silica gel, molecular sieve, CaCl₂, Na₂S0₄, activated carbon, silicates, bentonites, zeolites, and/or mixtures thereof. The desiccant is preferably arranged in the first and second hollow chamber of the main body.

In a preferred embodiment, the first glazing interior leg and/or the second glazing interior leg have at least one opening. Preferably, multiple openings are made in both glazing interior legs. The total number of openings depends on the size of the insulating glazing unit. The openings connect the hollow chambers to the interpane spaces, as a result of which a gas exchange between them becomes possible. This enables absorption of atmospheric moisture by a desiccant situated in the hollow chambers and thus prevents fogging of the panes. The openings are preferably implemented as slots, particularly preferably as slots with a width of 0.2 mm and a length of 2 mm. The slots ensure maximum air exchange without the desiccant being able to penetrate out of the hollow chambers into the interpane spaces.

The main body preferably contains in the embodiment made of one or a plurality of polymers polyethylene (PE) both of high density (HD) and also of low density (LD), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

Preferably, the polymeric main body is glass-fiber-reinforced. Through the selection of the glass fiber content in the main body, the coefficient of thermal expansion can be varied and adjusted. Temperature-induced stresses between the different materials and flaking of the insulating film can be prevented by matching the coefficient of thermal expansion of the polymeric main body and of the optional outer insulating film. The main body preferably has a glass fiber content of 20% to 50%, particularly preferably of 25% to 40%. The glass fiber content in the polymeric main body simultaneously improves its strength and stability. The glass fiber content can be partially substituted by hollow glass beads in order to further increase the thermal insulating effect without significant deterioration of mechanical strength.

The spacer according to the invention is preferably used in multiple glazings, preferably in insulating glazing units, particularly preferably in triple insulating glazing units.

The invention further relates to a method for producing a spacer for insulating glazing units with the following steps: In a first extrusion step, a polymeric main body is extruded. The polymeric main body has a first pane contact leg, a second pane contact leg running parallel thereto, a first glazing interior leg, a second glazing interior leg, an outer leg, a first hollow chamber extending along an extension direction, a second hollow chamber extending along the extension direction, and a groove with a first groove side leg and a second groove side leg for receiving a pane. The groove runs between the first hollow chamber and the second hollow chamber along the extension direction; and the first hollow chamber is, viewed in cross-section, enclosed by the first pane contact leg, the first glazing interior leg, and a first section of the outer leg; and the second hollow chamber is, viewed in cross-section, enclosed by the second pane contact leg, the second glazing interior leg, and a second section of the outer leg. In a second extrusion step, which is carried out with a time delay after the first extrusion step, a pane receiving socket, which is formed from a polymer with Shore hardness A, measured per DIN ISO 7619-1, in the range from 10 to 80, preferably in the range from 20 to 60, and particularly preferably in the range from 40 to 60 and which is extended at least in sections along the extension direction, is introduced into the groove.

With the method according to the invention, an economical spacer that can be further processed particularly advantageously in the production of multiple insulating glazing units can be produced in a simple manner. In particular, the spacer thus produced has the advantage of being sawable and millable without clogging sawing and milling tools.

In a preferred embodiment, a thermoplastic elastomer selected from the group consisting of TPA, TPC, TPS, TPU, or TPV is used as polymer for the pane receiving socket in the second extrusion step.

After the first and before the second extrusion step, a calibration step is carried out. In the calibration step, the polymeric main body of the spacer is subjected preferably to vacuum and cooling process steps in order to fix the structure and the dimensioning of the spacer after the extrusion step. Moreover, the calibration step preferably includes a perforation operation for forming openings in the two glazing interior legs. These openings are preferably implemented as slots, particularly preferably as slots with a width of 0.2 mm and a length of 2 mm.

In a preferred embodiment, after the second extrusion step, a profiling step is carried out such that a receiving recess, decreasingly tapering viewed in cross-section in the direction of the outer leg, is molded into the polymer of the pane receiving socket. The profiling step is preferably carried out using a profiling tool, while the polymer of the pane receiving socket is not yet cooled after the second extrusion step. Preferably used as a profiling tool is a stamping tool. The stamping tool is made, for example, of Teflon.

After the profiling step, the spacer is provided with functional layers or films on the outer leg and on the glazing interior legs. This has already been described above.

For further processing in the production of multiple insulating glazing units, the spacer is cut using sawing and/or milling operations. By these operations, the spacer for a multiple insulating glazing unit can be provided cut to the desired dimensions that are adapted to the pane sizes of the desired multiple insulating glazing unit. Customarily, after the cutting of the spacer, its hollow chambers are filled to a desired extent with desiccant.

The invention further relates to a multiple insulating glazing unit at least comprising a first pane, a second pane, and a third pane arranged as an inner pane, and the circumferential spacer according to the invention on the edges of the panes spacing the panes. The first pane rests against the first pane contact leg of the spacer and the second pane rests against the second pane contact leg. The inner pane is inserted in the groove with the pane receiving socket of the spacer. The inner pane is inserted into the groove with the pane receiving socket of the spacer.

At the corners of the insulating glazing unit, the spacers are preferably linked to each other via corner connectors. Such corner connectors can, for example, be implemented as molded plastic parts with a seal in which two spacers provided with a miter cut abut. In principle, a large variety of geometries of insulating glazing units are possible, for example, rectangular, trapezoidal, and rounded shapes. For producing curved geometries, the spacer according to the invention can, for example, be bent in the heated state.

The panes of the insulating glazing unit are preferably connected to the spacer via a seal. For this, a seal is placed between the first pane and the first pane contact leg and/or the second pane and the second pane contact leg. The seal preferably includes a polymer or a silane-modified polymer, particularly preferably organic polysulfides, silicones, room temperature vulcanizing silicone rubber, high temperature vulcanizing silicone rubber, peroxide vulcanizing silicone rubber, and/or addition vulcanizing silicone rubber, polyurethanes, butyl rubber, in particular polyisobutylene, and/or polyacrylates.

In the edge region between the outer leg of the spacer according to the invention and outer edges of the panes, an outer insulation is preferably filled in circumferentially. Used as outer insulation is, for example, a plastic sealing compound. Preferably the outer insulation includes polymers or silane-modified polymers, particularly preferably organic polysulfides, silicones, room temperature vulcanizing silicone rubber (RTV), high temperature vulcanizing (HTV) silicone rubber, peroxide vulcanizing silicone rubber, and/or addition vulcanizing silicone rubber, polyurethanes, butyl rubber, in particular polyisobutylene-based hot-melt adhesives, and/or polyacrylates.

Preferably, the interpane spaces between outer panes and inner panes are filled with a protective gas before pressing of the pane arrangement. The insulating glazing unit is preferably filled with a noble gas, preferably argon or krypton, which reduce the heat transfer value in the intermediate space of the insulating glazing unit. Alternatively, the multiple insulating glazing unit is filled with air.

The panes used for multiple insulating glazing units preferably contain glass and/or polymers, particularly preferably quartz glass, borosilicate glass, soda lime glass, polymethyl methacrylate, and/or mixtures thereof.

The outer panes preferably have a thickness from 2 mm to 50 mm, preferably 3 mm to 16 mm, with the two panes even possibly having different thicknesses. The inner pane preferably has a thickness from 1 mm to 4 mm, preferably from 1 mm to 3 mm and particularly preferably from 1.5 mm to 3 mm. The spacer according to the invention enables, through stress-free fixing of the inner pane, an advantageous reduction in the thickness of the inner pane while maintaining the stability of the glazing unit. Preferably, the thickness of the inner pane is less than the thickness of the outer pane. In a possible embodiment of a triple insulating glazing unit, the thickness of the first pane is 3 mm; the thickness of the second pane, 4 mm; and the thickness of the inner pane, 2 mm. When the outer pane of a multiple insulated glazing unit facing an external source of noise is significantly thicker, this significantly increases the noise reduction of the multiple insulating glazing unit. The total weight can be kept constant if the inner pane is thinner and the outer pane is correspondingly thicker.

The inner pane of the multiple insulating glazing unit preferably has a low-E coating. The inner pane of the insulating glazing unit is preferably not prestressed or is free of prestressing. The multiple insulating glazing unit is preferably a triple insulating glazing unit.

In another embodiment, the insulating glazing unit includes more than three panes. The spacer can include a plurality of grooves with an associated pane receiving socket that can receive additional panes. Alternatively, multiple panes can even be configured as a composite glass pane.

The multiple insulating glazing unit according to the invention can be produced, for example, as a triple insulating glazing unit by means of the following steps with the use of the above-described spacer:

a) Insertion of the inner pane into the groove of the spacer cut to size for the edges of the inner pane with the pane receiving socket provided therein,
b) Mounting the first pane on the first first pane contact leg of the spacer,
c) Mounting the second pane on the second pane contact leg of the spacer, and
d) Pressing the pane assembly.

Before the pressing of the pane assembly, the spacers are connected to one another at their corner regions via corner angles and/or, for example, ultrasonic welding.

Optionally, between step a) and step b), a seal can be applied on the first pane contact leg; and between step a) and step b) or step c), another seal can be applied on the second pane contact leg. Optionally, between step c) and step d), interpane spaces formed between the first pane and the inner pane as well as between the second pane and the inner pane can also be filled with protective gas.

In the following, the invention is explained in detail with reference to drawings. The drawings are purely schematic representations and are not true to scale. They in no way limit the invention. They depict:

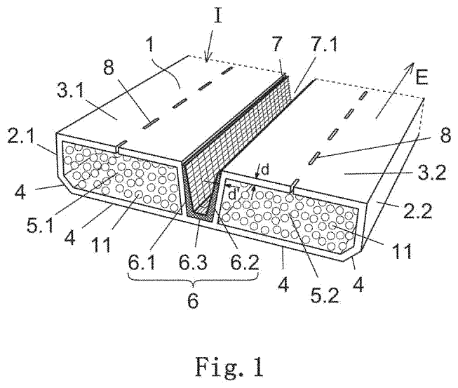

FIG. 1 a perspective view of a possible embodiment of the spacer according to the invention,

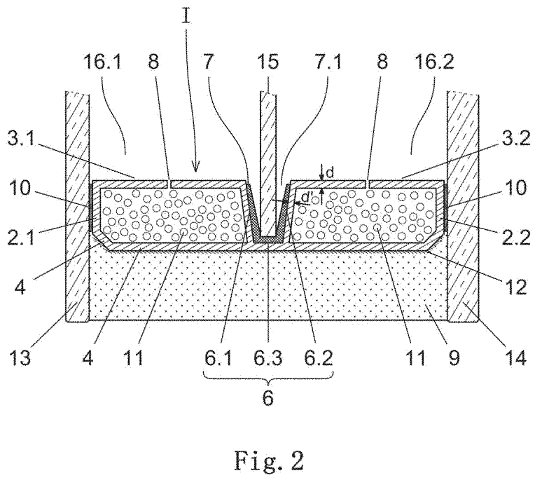

FIG. 2 a cross-section of a possible embodiment of the multiple insulating glazing unit according to the invention,

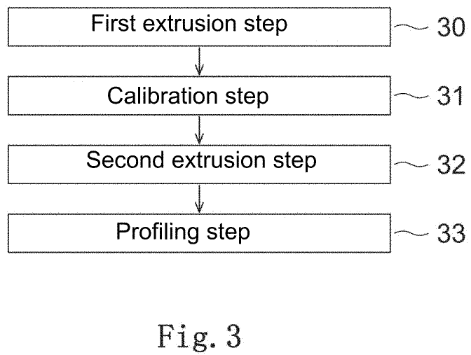

FIG. 3 a flowchart of a possible embodiment of a method according to the invention for producing a spacer, and

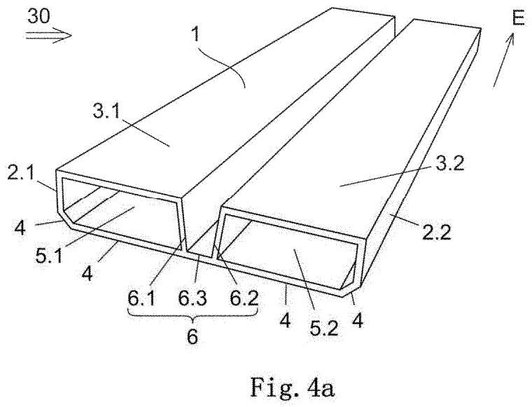

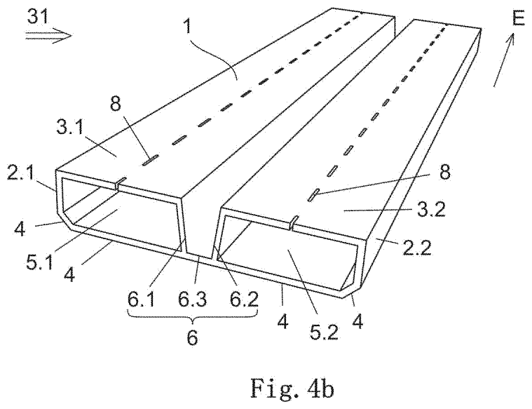

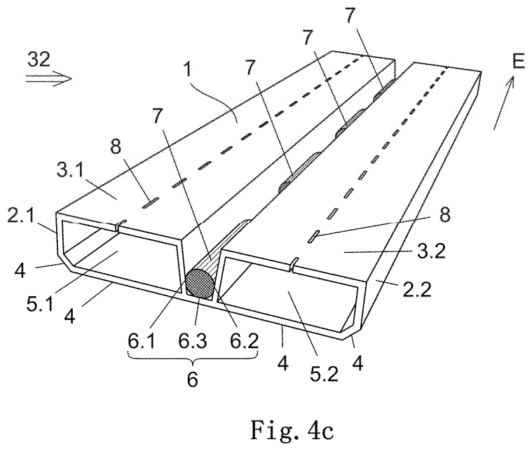

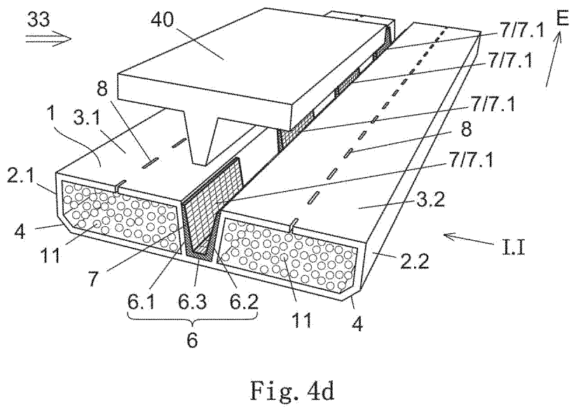

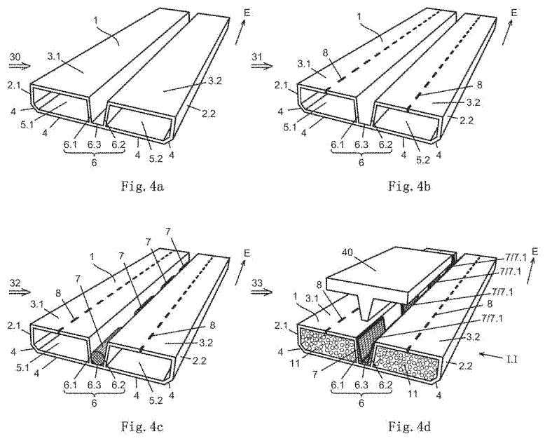

FIGS. 4a to 4d a method according to the invention for producing a spacer in accordance with another possible embodiment of the spacer.

FIG. 1 depicts a view of a possible embodiment of the spacer I according to the invention. The spacer I has a polymeric main body 1 that can be glass-fiber-reinforced. The polymeric main body 1 comprises a first pane contact leg 2.1, a second pane contact leg 2.2 running parallel thereto, a first glazing interior leg 3.1, a second glazing interior leg 3.2, and an outer leg 4. Situated between the outer leg 4 and the first glazing interior leg 3.1 is a first hollow chamber 5.1, which extends in an extension direction E, whereas a second hollow chamber 5.2 is arranged between the outer leg 4 and the second glazing interior leg 3.2 and extends parallel to the first hollow chamber 5.1 parallel to the extension direction E. Situated between the two hollow chambers 5.1, 5.2 is a groove 6, which also runs parallel to the extension direction E. A first groove side leg 6.1 and a second groove side leg 6.2 are formed by the walls of the two hollow chambers 5.1, 5.2, while a bottom surface 6.3 of the groove 6 is directly adjacent the outer leg 4. Thus, a maximum depth of the groove 6 is achieved. The two groove side legs 6.1, 6.2 of the groove 6 are inclined inward in the direction of an inner pane (not shown) to be received in the groove 6 such that the groove 6 is implemented as a recess decreasingly tapering in the direction toward the outer leg 4. A wall thickness d of the polymeric main body is 1 mm, while a reduced wall thickness d′ in the region of the groove side legs 6.1, 6.2 is 0.8 mm. The outer leg 4 runs for the most part perpendicular to the pane contact legs 2.1, 2.2 and parallel to the glazing interior legs 3.1, 3.2. The sections of the outer leg 4 nearest the pane contact legs 2.1, 2.2 are, however, inclined at an angle of preferably 30° to 60° relative to the outer leg 4 in the direction of the pane contact legs 2.1, 2.2. This angled geometry improves the stability of the polymeric main body 1 and enables improved adhesion of the spacer I according to the invention to an insulating film (not shown). The glazing interior legs 3.1, 3.2 have, at regularly spaced intervals, openings 8 that connect the hollow chambers 5.1, 5.2 to the air space located above the glazing interior legs 3.1, 3.2. The spacer I has a height of 6.5 mm and a total width of 34 mm. The groove 6 has a depth of 3 mm, while the first glazing interior leg 3.1 and the second glazing interior leg 3.2 are, in each case, 16 mm wide. The first hollow chamber 5.1 and the second hollow space 5.2 are filled, at least in sections, with a desiccant 11. A pane receiving socket 7, which is extended, at least in sections, parallel to the extension direction E and which is formed from a polymer with Shore hardness A in the range from 40 to 60, measured per DIN ISO 7619-1, is arranged in the groove 6. The pane receiving socket 7 has a receiving recess 7.1 decreasingly tapering in the direction of the outer leg 4. This spacer I can be further processed without problems—in particular, sawed and milled—in order to be provided with dimensions required for a multiple insulating glazing unit.

FIG. 2 depicts a cross-section of a possible embodiment of the multiple insulating glazing unit using the spacer described in FIG. 1. The multiple insulating glazing unit is implemented as a triple insulating glazing unit. Consequently, for describing the spacer I, reference is made to the statements made in reference to FIG. 1. A first pane 13 of the triple insulating glazing unit is connected to the first pane contact leg 2.1 of the spacer I via a seal 10, while a second pane 14 is connected to the second pane contact leg 2.2 via another seal 10. The seals 10 are made in each case of butyl rubber. In the groove 6 of the spacer I, a third pane 15 arranged as an inner pane is inserted into the pane receiving socket 7. The pane receiving socket 7 encloses one edge of the third pane 15. The pane receiving socket 7 is made of a thermoplastic polymer. It fixes the third pane 15 without stress and compensates thermal expansion of the third pane 15. Moreover, the pane receiving socket 7 prevents noise development due to mechanical movement (in sections) of the third pane 15. A first interpane space 16.1 is defined between the first pane 13 and the third pane 15, and a second interpane space 16.2 is defined between the third pane 15 and the second pane 14. A surface of the first glazing interior leg 3.1 of the spacer I is adjacent the first interpane space 16.1, while a surface of the second glazing interior leg 3.2 is adjacent the second interpane space 16.2. The interpane spaces 16.1, 16.2 and are connected to the respective hollow chamber 5.1, 5.2 respectively located therebelow via the openings 8 in the glazing interior legs 3.1, 3.2. The desiccant 11 consisting of molar sieve is situated in the hollow chambers 5.1, 5.2. A gas exchange between the hollow chambers 5.1, 5.2 and the interpane spaces 16.1, 16.2 occurs through the openings 8, by which means the desiccant 11 can withdraw atmospheric moisture from the interpane spaces 16.1, 16.2. Also, an insulating film 12 that gastightly blocks the passage of external moisture to the polymeric main body 1 is applied on the outer leg 4 of the spacer I. The insulating film 12 can be secured on the polymeric main body 1, for example, by a polyurethane hotmelt adhesive. The insulating film 12 includes four polymeric layers made of polyethylene terephthalate with a thickness of 12 μm and three metallic layers made of aluminum with a thickness of 50 nm. The metallic layers and the polymeric layers are, in each case, alternatingly applied, with the two outer plies formed by polymeric layers. The first pane 13 and the second pane 14 protrude beyond the spacer I creating a circumferential edge region that is filled with outer insulation 9. This outer insulation 9 is formed by an organic polysulfide. The first pane 13 and the second pane 14 are made of soda lime glass with a thickness of 3 mm, while the inner pane 15 is made of soda lime glass with a thickness of 2 mm. In place of the spacer I depicted in FIG. 1, the multiple insulating glazing unit depicted in FIG. 2 can include the spacer I.I depicted below in FIG. 4d and described with reference to FIG. 4d.

FIG. 3 depicts a flowchart of a possible embodiment of the method according to the invention for producing a spacer, for example, the spacer I depicted in FIG. 1. First, a first extrusion step 30 is carried out. After the first extrusion step 30, the polymeric main body 1 of the spacer I depicted in FIG. 1, as it is described in FIG. 1, is obtained. The extension direction E mentioned in FIG. 1 corresponds to the extrusion direction. A calibration step 31 follows the first extrusion step 30, in which the polymeric main body 1 is subjected to vacuuming and cooling operations for fixing its structure and, thereafter, perforated to form the openings 8 depicted in FIG. 1. After the calibration step 31, a second extrusion step 32 is carried out, in which a material for the pane receiving socket 7 depicted in FIG. 1 that is formed from a polymer with Shore hardness A in the range from 40 to 60, measured per DIN ISO 7619-1, extending at least in sections along the extension direction E, is injected into the groove 6 of the polymeric main body 1 depicted in FIG. 1. After the second extrusion extrusion step 32, a profiling step 33 is carried out such that a receiving recess 7.1, which is depicted in FIG. 1, decreasingly tapered viewed in cross-section in the direction of the outer leg 4, is molded in the polymer of the pane receiving socket 7. Downstream from that, the hollow chambers 5.1 and 5.2 are filled with desiccant 11. However, this regularly occurs only after completion of the cutting of the spacer to form a spacer strut for the assembly of an insulating glazing unit. Before the spacer strut is installed the insulating glazing unit, it must be filled with desiccant to the extent desired.

FIG. 4a through 4d depict a method according to the invention for producing another spacer in accordance with another possible embodiment. The method depicts the steps 30 through 33 previously mentioned in conjunction with FIG. 3. Statements made there thus apply accordingly. FIG. 4a depicts the polymeric main body 1 for the spacer, as it is obtained after the first extrusion step 30 from a starting material (not shown). The polymeric main body 1 depicted in FIG. 4a corresponds to the polymeric main body 1 depicted in FIG. 1; consequently, reference is made for the description of this polymeric main body 1 to the statements concerning FIG. 1. After a subsequent calibration step 31, the polymeric main body 1 depicted in FIG. 4b is obtained, which, in contrast to the polymeric main body 1 depicted in FIG. 4a is structurally fixed and has hollow chambers 5.1 and 5.2 together with openings 8 arranged therein.

The polymeric main body 1 depicted in FIG. 4b is subjected to a second extrusion step 32, as a result of which the polymeric main body 1 depicted in FIG. 4c is obtained, in whose groove 6 a polymer for the pane receiving socket 7 is arranged, in sections, such that it extends along the groove 6 in the extension direction E. The pane receiving socket 7 is introduced into the group 6 in segments such that a plurality of segments, three are depicted by way of example, extend, spaced apart from one another, in the groove 6 parallel to the extension direction E. The segments cover at least a bottom (not shown) of the groove 6 together with the first groove side leg 6.1 and the second groove side leg 6.2 in a predefined thickness or, alternatively, completely fill the groove 6 in sections, whereas regions of the groove 6 not covered by the segments of the pane receiving socket 7 represent regions free or substantially free of the polymer of the pane receiving socket 7. The spacer depicted in FIG. 4c is subjected in a profiling step 33 with the use of a profiling tool 40, which is pulled along parallel to the extension direction E along the polymer of the pane receiving socket 7 such that a receiving recess 7.1 decreasingly tapered viewed in cross-section in the direction of the outer leg 4 is introduced into the pane receiving socket 7. FIG. 4d depicts a spacer I.I according to the invention. This spacer I.I can be further processed without problems—in particular, sawed and milled—in order to be provided with necessary dimensions for a multiple insulating glazing unit.

### LIST OF REFERENCE CHARACTERS

d wall thickness
d′ reduced wall thickness
E extension direction
I spacer
I.I spacer
1 polymeric main body
2.1 first pane contact leg
2.2 second pane contact leg
3.1 first glazing interior leg
3.2 second glazing interior leg
4 outer leg
5.1 first hollow chamber
5.2 second hollow chamber
6 groove
6.1 first groove side leg
6.2 second groove side leg
6.3 bottom surface
7 pane receiving socket
7.1 decreasingly tapering receiving recess
8 openings
9 outer insulation
10 seal
11 desiccant
12 insulating film
13 first pane
14 second pane
15 third pane
16.1 first interpane space
16.2 second interpane space
30 first extrusion step
31 calibration step
32 second extrusion step
33 profiling step
40 profiling tool

1.-13. (canceled)

14. A spacer for insulating glazing units, the spacer comprising an extruded main body, comprising:
a first pane contact leg;
a second pane contact leg parallel to the first pane contact leg;
a first glazing interior leg;
a second glazing interior leg;
an outer leg;
a first hollow chamber extending along an extension direction;
a second hollow chamber extending parallel to the extension direction; and
a groove comprising a first groove side leg and a second groove side leg for receiving a pane,
wherein the groove runs between the first hollow chamber and the second hollow chamber along the extension direction,
wherein viewed in cross-section,
i) the first hollow chamber is enclosed by the first pane contact leg, the first glazing interior leg, and a first section of the outer leg, and
ii) the second hollow chamber is enclosed by the second pane contact leg, the second glazing interior leg, and a second section of the outer leg,
wherein arranged in the groove, there is an extruded pane receiving socket that extends at least in sections along the extension direction,
wherein the pane receiving socket is formed from a polymer having a Shore hardness A in a range from 10 to 80, measured per DIN ISO 7619-1, and
wherein in a surface of the pane receiving socket a receiving recess is implemented, the receiving recess running substantially parallel to the groove and decreasingly tapering viewed in cross-section in a direction of the outer leg.

15. The spacer according to claim 14, wherein the Shore hardness A is in a range from 40 to 60.

16. The spacer according to claim 14, wherein the receiving recess is molded into the surface of the pane receiving socket.

17. The spacer according to claim 14, wherein the polymer is a thermoplastic polymer selected from a group consisting of: TPA, TPC, TPS, TPU, and TPV.

18. The spacer according to claim 17, wherein the polymer is selected as a thermoplastic polymer from a group consisting of: TPU-ARES, TPU-AREE, and aliphatic TPUs.

19. The spacer according to claim 14, wherein the pane receiving socket is arranged in an interior of the groove.

20. The spacer according to claim 14, wherein viewed along the extension direction, the pane receiving socket runs continuously in the groove and has a substantially uniform cross-sectional area.

21. The spacer according to claim 14, wherein the first groove side leg and the second groove side leg are arranged so that the groove tapers decreasingly in the direction of the outer leg.

22. The spacer according to claim 14, wherein the polymer has a color with substantially no contrast relative to a surrounding surface of the extruded main body.

23. A method for producing a spacer for insulating glazing units, the method comprising:
A) extruding, in a first step, a polymeric main body comprising
a first pane contact leg,
a second pane contact leg that is parallel to the first pane contact leg,
a first glazing interior leg,
a second glazing interior leg,
an outer leg,
a first hollow chamber that extends along an extension direction,
a second hollow chamber that extends along the extension direction, and
a groove comprising a first groove side leg and a second groove side leg for receiving a pane,
wherein the groove runs between the first hollow chamber and the second hollow chamber along the extension direction, and
wherein viewed in cross-section,
i) the first hollow chamber is enclosed by the first pane contact leg, the first glazing interior leg, and a first section of the outer leg, and
ii) the second hollow chamber is enclosed by the second pane contact leg, the second glazing interior leg, and a second section of the outer leg; and
B) introducing into the groove, in a second step that is carried out with a time delay after the first step, a pane receiving socket that extends, at least in sections, along the extension direction, and is formed from a polymer having a Shore hardness A in a range from 10 to 80, measured per DIN ISO 7619-1.

24. The method according to claim 23, wherein the Shore hardness A is in a range from 40 to 60.

25. The method according to claim 23, wherein the polymer is a thermoplastic polymer that is selected from a group consisting of: TPA, TPC, TPS, TPU, and TPV.

26. The method according to claim 23, wherein a calibration step is carried out after the first step and before the second step in order to fix structure and dimensioning of the spacer after the extrusion.

27. The method according to claim 23, wherein after the second step, a profiling step is carried out, comprising molding into the polymer of the pane receiving socket, a receiving recess that, viewed in cross-section in a direction of the outer leg, is decreasingly tapered.

28. The method according to claim 27, wherein the profiling step is carried out using a profiling tool while the polymer of pane receiving socket has not cooled.

29. A multiple insulating glazing unit, comprising:
a first pane;
a second pane;
a third pane; and
a spacer according to claim 14 that is arranged circumferentially on respective edges of the first pane, the second pane and the third pane,
wherein the spacer separates the first pane, the second pane and the third pane apart from each other,
wherein the first pane rests against the first pane contact leg of the spacer,
wherein the second pane rests against the second pane contact leg of the spacer, and
wherein the third pane is inserted into the groove with the pane receiving socket of the spacer.
